(19) United States
(12) Patent Application Publication
(10) Pub. No.: US 2011/0225014 A1
(43) Pub. Date: Sep. 15, 2011

(54) WEB-BASED METHOD OF PERSONNEL MANAGEMENT

(76) Inventors: Amy Hixson, Sherman Oaks, CA (US); Jennifer Collins, Sherman Oaks, CA (US); Gerald Washington-Collins, Sherman Oaks, CA (US)

(21) Appl. No.: 13/046,587

(22) Filed: Mar. 11, 2011

Related U.S. Application Data
(60) Provisional application No. 61/313,355, filed on Mar. 12, 2010.

(51) Int. Cl. G06Q 10/00

(52) U.S. Cl. 705/7.21

(57) ABSTRACT

The present disclosure provides an application that can be manipulated by users with varying levels of access to schedule tasks for personnel. The application can be accessed remotely, through a web browser or mobile device. In one embodiment, the application is used by models, and their agents and agencies, to manage their schedules.

### CROSS-REFERENCE TO RELATED APPLICATIONS

The present application claims the benefit of U.S. Provisional Patent Application No. 61/313,355, filed on Mar. 12, 2010.

### BACKGROUND OF THE DISCLOSURE

1. Field of the Disclosure

The present disclosure relates to a method of managing and scheduling personnel for a variety of tasks. More particularly, the present disclosure relates to an application with which users, group managers, and administrators can manage and manipulate the schedules and activities of personnel.

2. Description of the Related Art

With most current creative industry professional employment services or agencies, appointments and schedules of creative industry professionals are typically conducted with telephone calls, e-mails, or perhaps a desktop-based software application. This can create a lot of difficulty and error, since the different ways of making the schedules are not coordinated. In addition, the creative industry professional may be employed by two or more different agencies. To see if they are free for a particular appointment, the creative industry professional must confer with each agency individually, as there is currently no way to coordinate between the different agencies. Similarly, there is no way for a manager or agent of that creative industry professional at one agency to know whether the creative industry professional is occupied at a particular time.

### SUMMARY OF THE DISCLOSURE

The present disclosure has developed an application to eliminate the above-described disadvantages. The application allows the creative industry professional, and a manager, agent, or anyone else acting on their behalf, to log into one location to manage the creative industry professional's schedule. In one embodiment, the application is used by models, and their agents and agencies, to manage their schedules.

Thus, in one embodiment, the present disclosure provides a storage medium having a program encoded thereon that is executable in a processor to perform a method. The method comprises presenting a scheduling interface, the scheduling interface showing a plurality of dates, allowing access to the scheduling interface for at least a user, a group manager, and an administrator, and allowing the group manager and the administrator to schedule a task for the user in the scheduling interface on one of the dates.

The present disclosure also provides a method, comprising presenting a scheduling interface, the scheduling interface showing a plurality of dates, allowing access to the scheduling interface for at least a user, a group manager, and an administrator, and allowing the group manager and the administrator to schedule a task for the user in the scheduling interface on one of the dates.

### BRIEF DESCRIPTION OF THE DRAWINGS

FIG. 1 shows an exemplary screen capture of the web-based application of the present disclosure, according to the user level of access;

FIG. 2 shows an exemplary screen capture of the web-based application of the present disclosure, according to the group manager level of access; and

FIG. 3 shows an exemplary screen capture of the web-based application of the present disclosure, according to the administrator level of access; and

FIG. 4 shows a directory for the web-based application of the present disclosure.

### DETAILED DESCRIPTION OF THE INVENTION

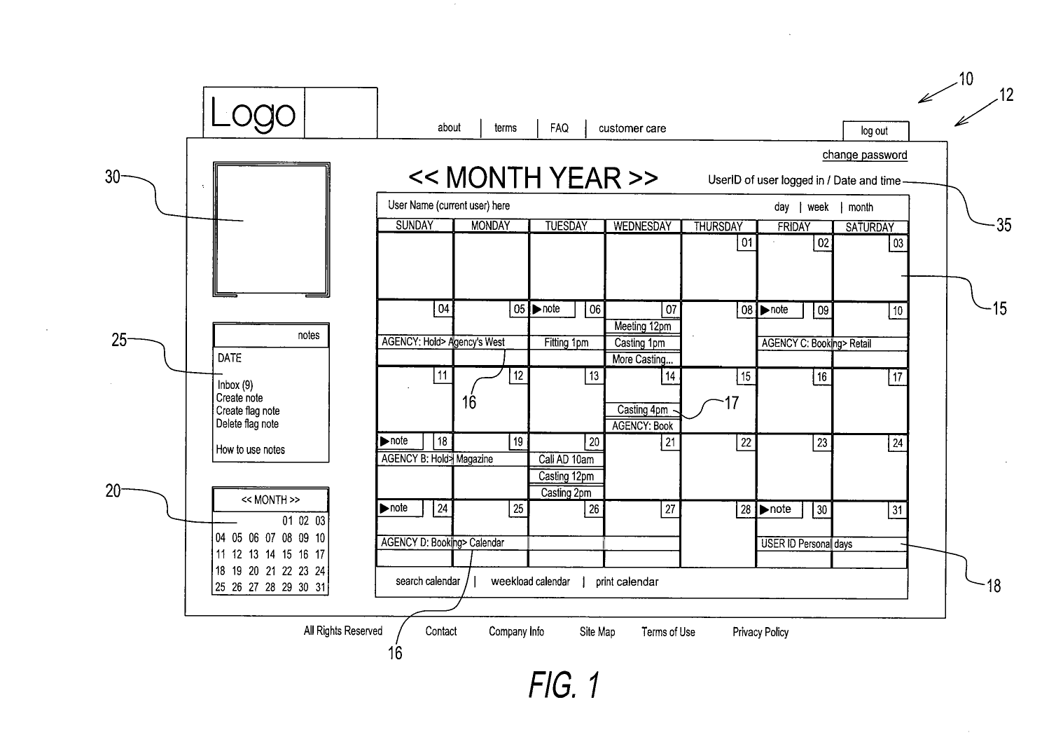

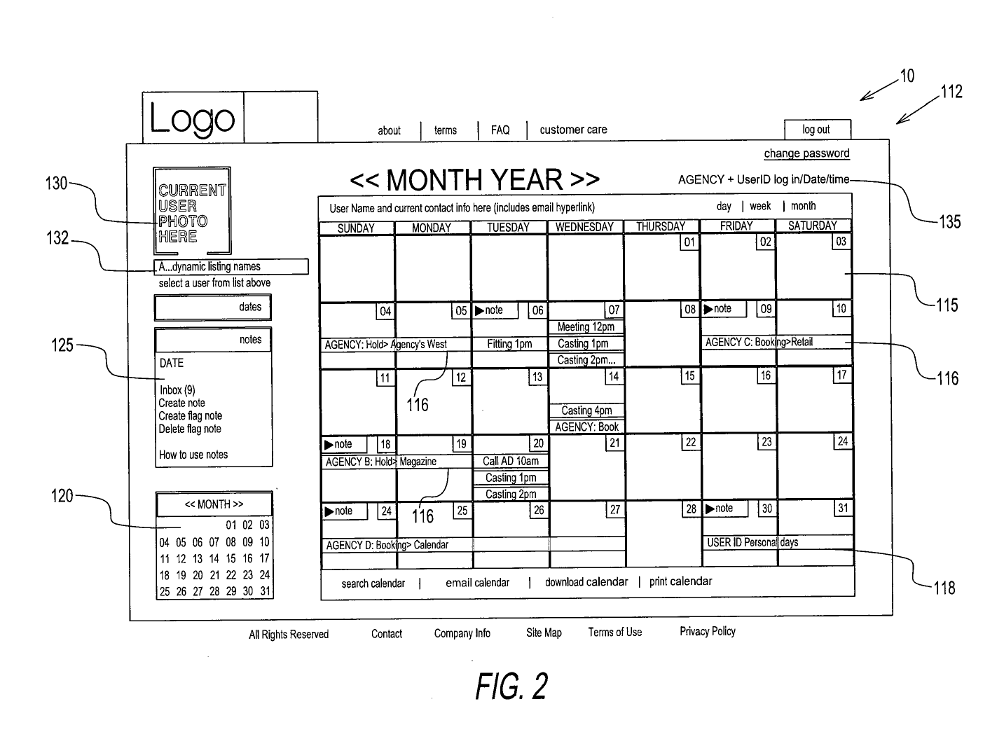

Referring to FIGS. 1-3, a sample screen capture of application 10 of the present disclosure is shown. The view of FIGS. 1 and 2 are merely exemplary, and the present disclosure contemplates other arrangements for the features discussed below. Application 10 can be a web-based program used for managing creative industry professionals and scheduling a variety of tasks for the same. As discussed above, application 10 enables managers to transition from their traditional modes of scheduling their personnel via telephone, email, and standalone desktop software. This can provide a substantial benefit in terms of time involved, and the ease of scheduling.

In the embodiment shown in FIGS. 1 and 2 and discussed below, application 10 is for scheduling models and other creative talent, who may be employed by multiple talent agencies, and the managers scheduling the tasks may be talent agents. In the modeling industry, a model can be employed by one or more agencies, and have one or more agents at each of those agencies. In this scenario, a model typically has one or more agents, and the agents are affiliated with a modeling agency. Application 10 may also be used for other types of employee placement services, for example actors, photographers, hairstylists, or makeup artists.

Membership to application 10 is acquired by signing a license agreement. Typically, the agency executes the license agreement. Application 10 establishes three levels of access: (a) users, such as models or other creative industry professionals, (b) group managers, such as agents for creative industry professionals that act on the user's behalf and are affiliated with an agency, or (c) administrators, which would be the staff responsible for running and maintaining application 10.

After joining, the administrators input the agency's creative industry professionals' data (e.g. biographical data related to the agency, subscription information, number of permitted users) into a database (not shown) that runs application 10. Thereafter, the users and group managers can remotely login to application 10 through a Web site, to view schedules, manage schedules, and utilize an internal messaging system in application 10. Application 10's bespoke relational database and web-based user interface can be hosted behind a firewall on a secure Apache server and utilize SSL (Secure Sockets Layer) protocols. Application 10's robust hosting measures ensure encrypted transmissions and secure storage of user data.

Although, for convenience's sake, the present disclosure describes application 10 as being web-based, application 10 is scaleable for use on mobile device operating systems (such as, but not limited to, Apple iPhone™ and Research in Motion's Blackberry™). Application 10 is unique in that it was developed specifically for cross-platform compatibility (enabling universal application access). A user will be able to access application 10 via a standard web browser, or purchase a device-specific software iteration from an applications store (for example, Apple Apps™, Blackberry Apps™).

The group manager can plan the creative industry professional's (user) schedule, and then create, delete, and revise that schedule in application 10 (but only to the extent that it doesn't interfere with the scheduling conducted by group managers at other agencies, as discussed in detail below). The group manager can also control how much—if any—details about the employment task (such as a Call Sheet in a modeling assignment) that the user or other group managers can view. For example, the group manager can allow the user to see what kind of work the assignment entails, what time it begins or ends, where it is located, or other relevant information. The user can login to view assignments and check messages.

One advantage of application 10 of the present disclosure is that it can facilitate scheduling between a creative industry professional (user), their agent or group manager, and multiple employers, or talent agencies. For example, as shown in FIGS. 1 and 2, in the case where application 10 is used for modeling employment, the user or model can be regularly employed by one or more modeling agencies, for example agency A, agency B, and agency C. The three agencies are wholly separate entities. In currently available methods, if the creative industry professional (user) wishes to know his or her schedule, they must separately confer with each respective agency. Currently, there is no way for multiple agencies to confer or coordinate schedules.

With application 10 the creative industry professional can log in to application 10 via a Web site (or with any of the other methods described above), and check her schedule with all agencies by which she is employed. The information displayed to the model or other creative industry professional, and to all other agencies, is controlled by the preferences of the group manager at each particular agency. Any of the agencies can log onto the Web site hosting application 10, and view the creative industry professional's (user) schedule. The agencies can see that the model or user is unavailable for a date, but cannot see what type of commitment she has with another agency, unless those details are provided by the agency that scheduled the appointment.

Thus, the present disclosure provides a single communication hub for the entire creative talent industry, or any other industry where a convenient, centrally located scheduling management tool would be of use. In the case of models and their employers, it will no longer be necessary to contact multiple agencies to confirm bookings or check assignment details. Both creative talent and talent agencies can use a single source to coordinate booking.

In addition, application 10 also provides the only industry-wide internal messaging system. The users, group managers, or employers/agencies can contact each other without needing to login to another email system. This presents significant advantages of convenience, ease of communication, and time savings over currently available methods. The model (user) or their agent (group manager) will only see messages to and from each other through this internal messaging system, as opposed to traditional mail applications, where such messages would get lost or buried beneath other communications. Application 10 is thus the first and only web-based scheduling system created specifically to address the needs of the model and creative talent management industry.

Referring to FIG. 1, an example of the user interface 12 the user sees when they log into application 10 is shown. The display can show a calendar in both a day at a glance mode 15, or month at a glance mode 20. Interface 12 can also have a messaging menu 25, and a profile 30, the latter of which can contain personal information about the user, such as a photograph or other personal details. Interface 12 can also have window 35, which can show the identification of the user logged in, and/or the date and time. Calendar view 15 can display several scheduled modeling appointments, for the same or different agencies, such as agency A, agency B, or agency C. Again, although the embodiment of FIG. 1 shows three different agencies, the present disclosure contemplates one or more different agencies.

Each day in calendar 15 can show the call details 16. Again, as discussed above, the amount of detail that the user can see upon logging into application 10 can be controlled by the group manager who schedules the particular event. Calendar 15 can also display messages 17 that are exchanged by the group manager and the user. For example, if the group manager wants the user to confirm that they are available at a particular time on a particular day, they can leave a message in that time slot on calendar 15 for the user to confirm. The user can also leave a number of messages 18 of their own, to indicate that they are unavailable at a particular time and day.

Messaging menu 25 is a message management tool that allows users, group managers, or administrators to communicate with each other through the interface. Menu 25 can have, for example, an inbox that indicates the arrival of a new message, folders for saving sent or received messages, and a contact list. Thus, as discussed above, application 10 provides an extremely convenient way for models, their agents, and their employers to communicate all together, in one very simple interface.

Application 10 can also have an internal invoice system. Group managers or agents can use the invoice system to track billing associates with the users or the particular tasks for which they are scheduled.

Referring to FIG. 2, a user interface 112 that a group manager sees when they log into application 10 is shown. Interface 112 can have similar features to interface 12, such as day at a glance calendar 115, month at a glance calendar 120, or messaging menu 125, and user ID window 135.

In interface 112, the group manager can also see messages 118 left by the user, or messages 116 indicating that the model is unavailable on that date, and/or already scheduled for a booking. Interface 112 can also have a dynamic drop down menu 132, where the group managers can see a listing of users. The group manager can select one of the names of the users, and that user's schedule will appear in interface 112. A photo and/or other personal details of that particular user can also appear in window 130. Thus, another significant advantage of application 10 is that a group manager can manage the schedules of several different users all within the same window, and can change between different users very easily.

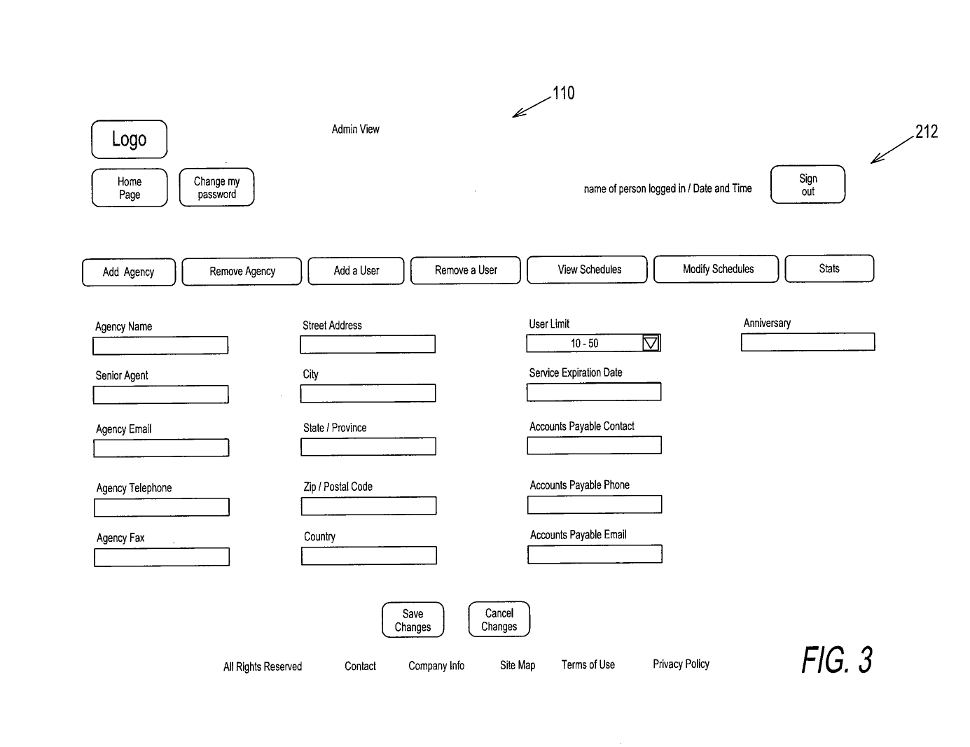

FIG. 3 shows a user interface 212 that an administrator sees when they log into application 10. As previously discussed the administrator has the ability to perform tasks not available to the users or group managers, such as adding or removing agencies, adding or removing a user, or viewing or modifying the schedules of users. Interface 212 also allows the administrator to view and/or change the biographical details of the agencies that subscribe to application 10, such as the agency's contact information, information relating to their subscription, and the number of group managers and users that can have access to application 10 at any given time. In certain embodiments, the number of users—both group managers and users—with access can range from 10-50, 51-100, 101-150, or 151-200, depending on the service plan purchased.

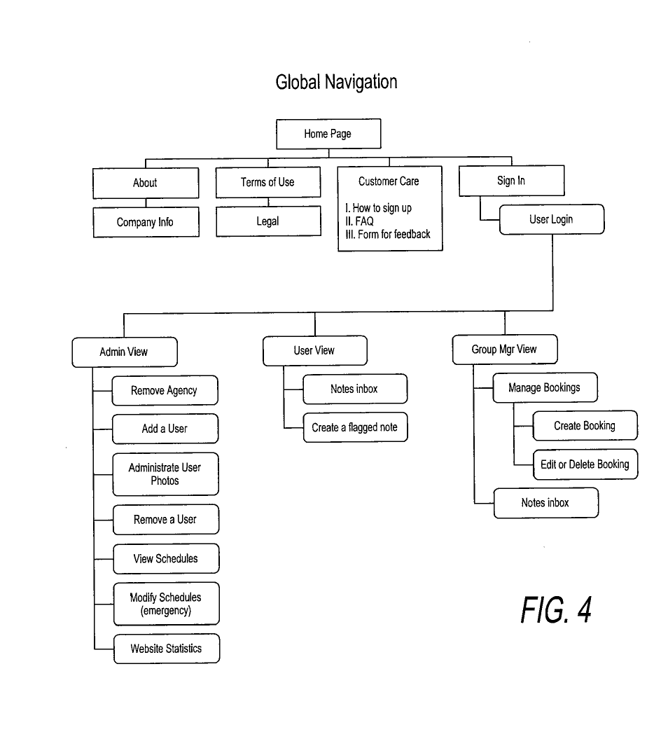

FIG. 4 shows one embodiment of a map of application 10 when it runs on a Web site. A person logging onto application 10 can first visit the home page, which can have links to “About,” “Terms of Use,” “Customer Care,” or “Sign In” screens. As previously discussed, there are three levels of access to application 10, and the sign in identification used will dictate where the person logging on is directed. In the case of an administrator, they are taken to a view that allows them to perform the various tasks shown. In the case of a user, they are taken to interface 12, as discussed above, where the user can manage their appointments, messages, and create flagged notes for the group manager they work with. (A flagged note on the user end (model) can be a reminder for something needed on a shoot. On the group manager (agent) end, it can be to relay info about flight credits, etc. The flagged note can be a more visible means of reminding the user of an event or action needed on a particular day.) In the case of a group manager, they are taken to interface 112, as described above, which will allow the group manager to manage, create, edit, or delete bookings for a particular user that the group manager is allowed to access, and also to the group manager's message center.

The present disclosure accomplishes schedule coordination by utilizing a proprietary, custom-built PHP5 scripting program. The scripting commands for application 10 will be executed on an Apache2 Web Server running MySQL5 or PostgreSQL8+ (depending on the server hosting environment), and utilize SSL (Secure Sockets Layer) protocols. Application 10 is optimized for use in readily available web browsers such as Firefox, Safari, and Internet Explorer. Moreover, future iterations of application 10 will be created using Apple and RIM's respective software development kits. As previously discussed, application 10 will handle multiple agencies in some instances scheduling the same creative talent pool.

While the present disclosure may discuss features in the singular case, it is understood that singular terms can also mean their plural equivalents where applicable. In addition, the present disclosure has been described with particular reference to certain embodiments. It should be understood that the foregoing descriptions and examples are only illustrative of the invention. Various alternatives and modifications thereof can be devised by those skilled in the art without departing from the spirit and scope of the present disclosure.

What is claimed is:

1. A storage medium having a program encoded thereon that is executable in a processor to perform a method, the method comprising:
presenting a scheduling interface, said scheduling interface showing a plurality of dates;
allowing access to said scheduling interface for at least a user, a group manager, and an administrator; and
allowing said group manager and said administrator to schedule a task for said user in said scheduling interface in one of said dates.

2. The storage medium of claim 1, wherein the method allows different levels of said access to said scheduling interface for each of said user, said group manager, and said administrator.

3. The storage medium of claim 1, wherein said group manager is a plurality of group managers.

4. The storage medium of claim 3, wherein said task has a plurality of details associated therewith, wherein at least some of said details associated with a task scheduled by one of said group managers is not visible to other group managers.

5. The storage medium of claim 3, wherein said method further comprises the step of prohibiting one of said group managers from scheduling a task at the same time as a task scheduled by another of said group managers.

6. The storage medium of claim 1, wherein said task has a plurality of details associated therewith, wherein at least some of said details associated with a task scheduled by said group manager or a task scheduled by said administrator are not visible to said user.

7. The storage medium of claim 1, wherein the method further comprises the step of allowing said user, group manager, and said administrator to communicate with each other through said scheduling interface.

8. The storage medium of claim 1, wherein the method further comprises the step of displaying a different version of said scheduling interface to each of said user, said group manager, and said administrator.

9. The storage medium of claim 3, wherein said allowing access step is conducted through a login screen for said scheduling interface that prompts each of said group managers for a password, and wherein each of said group managers has a different password than other group managers.

10. The storage medium of claim 1, wherein said access allowed to said administrator allows said administrator to perform functions within said scheduling interface that are not available to said user or said group manager.

11. A method, comprising:
presenting a scheduling interface, said scheduling interface showing a plurality of dates;
allowing access to said scheduling interface for at least a user, a group manager, and an administrator; and
allowing said group manager and said administrator to schedule a task for said user in said scheduling interface in one of said dates.

12. The method of claim 11, wherein the method allows different levels of said access to said scheduling interface for each of said user, said group manager, and said administrator.

13. The method of claim 11, wherein said group manager is a plurality of group managers.

14. The method of claim 13, wherein said task has a plurality of details associated therewith, and wherein at least some of said details associated with a task scheduled by one of said group managers is not visible to other group managers.

15. The method of claim 13, wherein said method further comprises the step of prohibiting one of said group managers from scheduling a task at the same time as a task scheduled by another of said group managers.

16. The method of claim 11, wherein said task has a plurality of details associated therewith, wherein at least some of said details associated with a task scheduled by said group manager or a task scheduled by said administrator are not visible to said user.

17. The method of claim 11, wherein the method further comprises the step of allowing is said user, group manager, and said administrator to communicate with each other through said scheduling interface.

18. The method of claim 11, wherein the method further comprises the step of displaying a different version of said scheduling interface to each of said user, said group manager, and said administrator.

19. The method of claim 13, wherein said allowing access step is conducted through a login screen for said scheduling interface that prompts each of said group managers for a password, and wherein each of said group managers has a different password than other group managers.

20. The method of claim 11, wherein said access allowed to said administrator allows said administrator to perform functions within said scheduling interface that are not available to said user or said group manager.
